(19) United States
(12) Patent Application Publication
(10) Pub. No.: US 2024/0194222 A1
(43) Pub. Date: Jun. 13, 2024

(54) PIVOT-TO-ENCLOSURE FASTENING FOR REDUCING TORSIONAL VIBRATION OF ACTUATOR COIL IN HARD DISK DRIVE

(71) Applicant: Western Digital Technologies, Inc., San Jose, CA (US)

(72) Inventors: Ko Takabayashi, Fujisawa (JP); Hajime Eguchi, Fujisawa (JP); Takeji Sumiya, Fujisawa (JP)

(21) Appl. No.: 18/128,862

(22) Filed: Mar. 30, 2023

Related U.S. Application Data
(60) Provisional application No. 63/431,553, filed on Dec. 9, 2022.

(51) Int. Cl. G11B 5/48; G11B 25/04

(52) U.S. Cl. CPC G11B 5/4813; G11B 25/043

(57) ABSTRACT

A hard disk drive includes a rotary actuator installed about a pivot having a hollow pivot shaft having a pivot shaft length, a base having a pivot boss shaft including an internal threaded portion and disposed within the pivot shaft, and a screw coupled with the threaded portion of the pivot boss shaft through a cover, where the screw has a fastening depth at which center threads of the threaded portion of the pivot boss shaft are coupled with screw threads at 66% or more of the pivot shaft length. Thus, the thermal expansion of the pivot boss shaft at high temperatures is inhibited and the corresponding axial fastening force of the screw is maintained, thereby inhibiting increasing coil torsion mode gain and lowering of the actuator main resonance frequency and consequent closer coupling with the coil torsion mode at high temperatures.

### CROSS-REFERENCE TO RELATED APPLICATIONS

This application claims the benefit of priority to commonly-owned pending U.S. Provisional Patent Application No. 63/431,553 filed on Dec. 9, 2022, the entire content of which is incorporated by reference for all purposes as if fully set forth herein.

### FIELD OF EMBODIMENTS

Embodiments of the invention may relate generally to data storage devices such as hard disk drives and particularly to approaches for improving the structural dynamics of the actuator.

### BACKGROUND

A hard disk drive (HDD) is a non-volatile storage device that is housed in a protective enclosure and stores digitally encoded data on one or more circular disks having magnetic surfaces. When an HDD is in operation, each magnetic-recording disk is rapidly rotated by a spindle system. Data is read from and written to a magnetic-recording disk using a read-write transducer (or read-write “head”) that is positioned over a specific location of a disk by an actuator. A read-write head makes use of magnetic fields to write data to, and read data from, the surface of a magnetic-recording disk. A write head works by using the current flowing through its coil to produce a magnetic field. Electrical pulses are sent to the write head, with different patterns of positive and negative currents. The current in the coil of the write head produces a localized magnetic field across the gap between the head and the magnetic disk, which in turn magnetizes a small area on the recording medium. The read head, in turn, senses the magnetization of those areas on the magnetic disk to form a read signal that is then processed and interpreted. Most components of an HDD are enclosed in a base and cover that contain the magnetic-recording disks, the spindle motor, the actuator with the magnetic read-write heads attached to its tips, and a voice coil motor actuator (“VCM” or “VCMA”). The actuator is driven by the VCM with a pivot shaft (or simply “pivot”) as the axis of rotation.

Any approaches that may be described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

Embodiments are illustrated by way of example, and not by way of limitation, in the figures of the accompanying drawings and in which like reference numerals refer to similar elements and in which:

FIG. 1 is a plan view illustrating a hard disk drive (HDD), according to an embodiment;

FIG. 2 is a graph generally depicting the frequency response of an HDD actuator;

FIG. 3 is a cross-sectional side view illustrating an HDD actuator pivot assembly, according to an embodiment;

FIG. 4 is a cross-sectional side view illustrating an improved HDD actuator pivot assembly, according to an embodiment; and

FIG. 5 is a flowchart illustrating a method of assembling a hard disk drive, according to an embodiment.

### DETAILED DESCRIPTION

Generally, approaches to pivot-to-enclosure fastening improvements to reduce torsional vibration of the coil in an HDD are described. In the following description, for the purposes of explanation, numerous specific details are set forth in order to provide a thorough understanding of the embodiments of the invention described herein. It will be apparent, however, that the embodiments of the invention described herein may be practiced without these specific details. In other instances, well-known structures and devices may be shown in block diagram form in order to avoid unnecessarily obscuring the embodiments of the invention described herein.

### INTRODUCTION

### Terminology

References herein to “an embodiment”, “one embodiment”, and the like, are intended to mean that the particular feature, structure, or characteristic being described is included in at least one embodiment of the invention. However, instances of such phrases do not necessarily all refer to the same embodiment,

The term “substantially” will be understood to describe a feature that is largely or nearly structured, configured, dimensioned, etc., but with which manufacturing tolerances and the like may in practice result in a situation in which the structure, configuration, dimension, etc. is not always or necessarily precisely as stated. For example, describing a structure as “substantially vertical” would assign that term its plain meaning, such that the sidewall is vertical for all practical purposes but may not be precisely at 90 degrees throughout.

While terms such as “optimal”, “optimize”, “minimal”, “minimize”, “maximal”, “maximize”, and the like may not have certain values associated therewith, if such terms are used herein the intent is that one of ordinary skill in the art would understand such terms to include affecting a value, parameter, metric, and the like in a beneficial direction consistent with the totality of this disclosure. For example, describing a value of something as “minimal” does not require that the value actually be equal to some theoretical minimum (e.g., zero), but should be understood in a practical sense in that a corresponding goal would be to move the value in a beneficial direction toward a theoretical minimum.

### Context

Hard disk drives (HDDs) are widely used in data centers, with continuous requests for increased capacity and improved performance. To improve the positioning accuracy of the magnetic head, consideration may be given to improving the bandwidth of servo control and a reduction of actuator frequency response changes based on temperature changes is considered beneficial to that end.

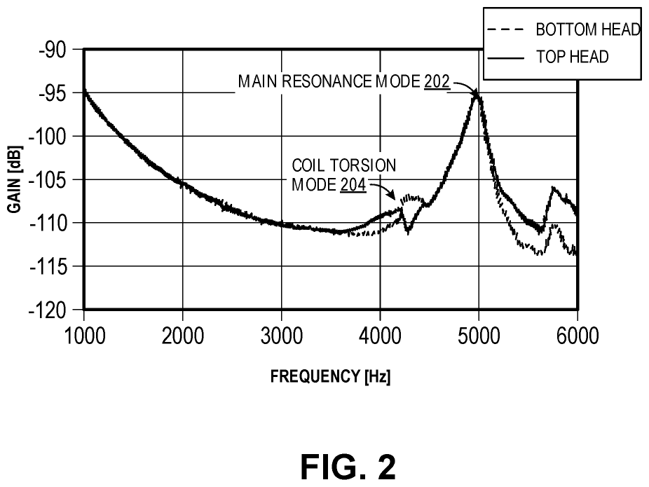

FIG. 2 is a graph depicting an example frequency response of an HDD actuator. FIG. 2 represents an example of the frequency responses from the current in the actuator coil to the head displacements. In addition to the rigid body mode characterizing the actuator rotating about the pivot shaft, a main resonance mode 202 characterizing the actuator deforming in a bow shape and the coil torsion mode 204 are seen in frequency responses of the actuator. The coil torsion mode is the lowest-frequency vibration mode in the frequency response function, with gains widely varying due to the external temperature and manufacturing variations. Therefore, the servo controller design must maintain a margin for ensuring control stability, which is a constraint to improving the control bandwidth. Thus, the excitation factor of in-plane forces in the coil torsion mode, such as in the context of actuator system stiffness variations, is an area in which improvements may be made.

### Pivot-Enclosure Fastening Improvements for Reduction of Coil Torsional Vibration

A usage study of HDDs found ambient temperatures in a range of 40-60 degrees Celsius (° C.), and that the coil torsion mode is excited more as the temperature increases. Hence, reduction of coil torsion mode gain at high temperatures is an area of interest.

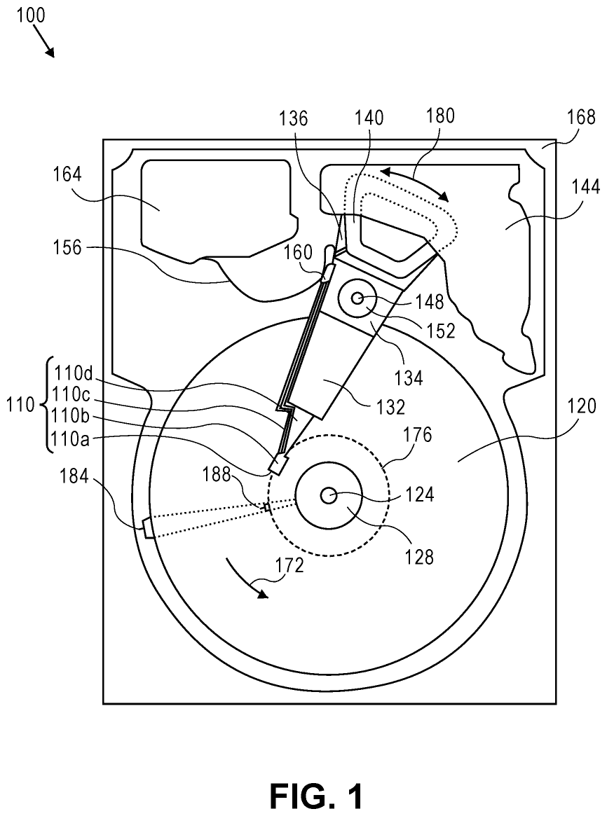

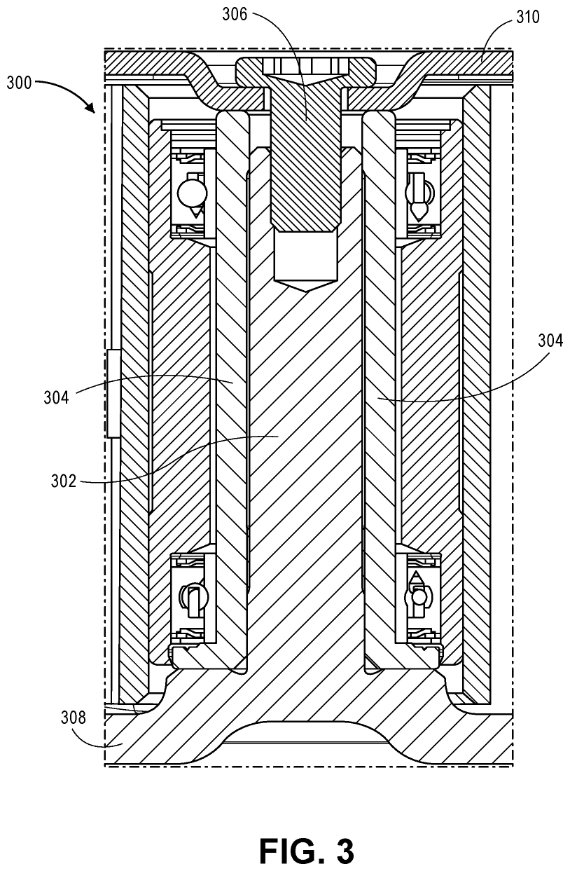

FIG. 3 is a cross-sectional side view illustrating an HDD actuator pivot assembly, according to an embodiment. Pivot assembly 300 is the mechanism about which an HDD rotary actuator assembly rotates or pivots (see, e.g., pivot shaft 148 with interposed pivot bearing assembly 152 of FIG. 1). Because the base pivot boss shaft 302 has a higher coefficient of thermal expansion (“CTE”) than the pivot shaft 304, the axial force of the pivot screw 306 decreases due to the expansion of the pivot boss shaft 302, with which the screw 306 is mechanically coupled/fastened/threaded, relative to the pivot shaft 304 at high temperatures. This decrease of the axial force of the screw 306 lowers the frequency of the main resonance (see, e.g., main resonance mode 202 of FIG. 2). The actuator assembly is designed to be symmetric in the vertical direction about the coil (see, e.g., voice coil 140 of FIG. 1), and thus the in-plane force on the coil does not cause the vibration of coil torsion mode in the normal condition. However, when the rigidity of the base 308 (see also, e.g., housing 168 of FIG. 1) and the cover 310 around the pivot shaft 304 are different, the decrease of the axial force of the screw 306 results in the support conditions of the pivot shaft 304 being asymmetric and, therefore, the coil torsion mode (see, e.g., coil torsion mode 204 of FIG. 2) becomes more closely coupled (e.g., closer in frequency) with the main resonance mode 202.

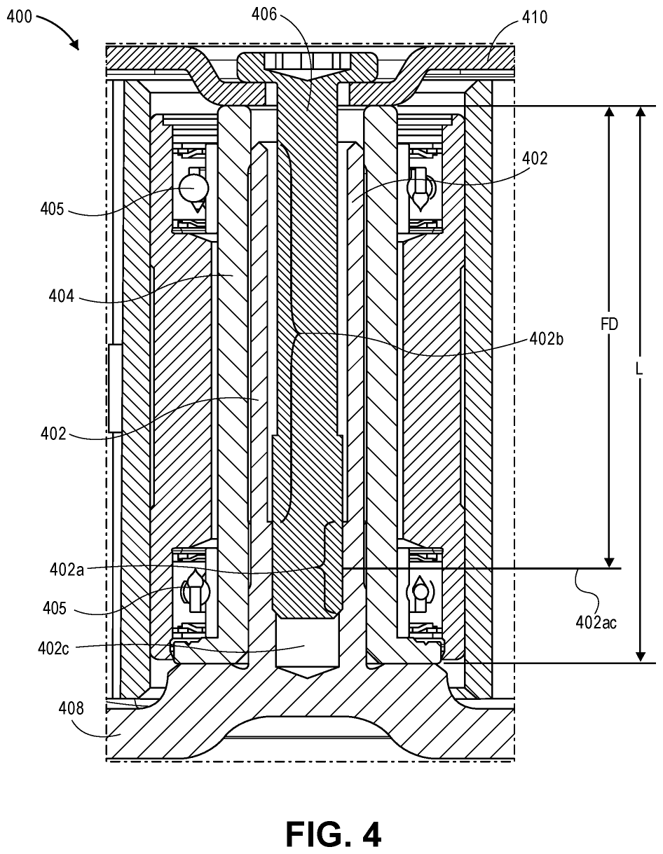

FIG. 4 is a cross-sectional side view illustrating an improved HDD actuator pivot assembly, according to an embodiment. Note that FIG. 4 may not be drawn to a precise scale in relation to the relative lengths and depths and percentages described in more detail hereafter. As described, a pivot assembly such as pivot assembly 400 is a mechanism (generally referred to as the “pivot”) about which an HDD rotary actuator assembly rotates or pivots (see, e.g., pivot shaft 148 with interposed pivot bearing assembly 152 of FIG. 1). According to an embodiment, the “pivot” of pivot assembly 400 comprises a hollow (at least partially in length) shaft 404 which has a corresponding pivot shaft length, labeled “L”. According to an embodiment, pivot assembly 400 further comprises a corresponding one or more bearing ring 405 (e.g., ball bearing ring) disposed or positioned around the pivot shaft 404. Pivot assembly 400 further comprises a pivot boss shaft 402 at least in part disposed within the pivot shaft 404, as depicted. According to an embodiment, the pivot boss shaft 402 is integrally formed with an enclosure base 408 (see also, e.g., housing 168 or “base” of FIG. 1).

Pivot boss shaft 402 comprises an internal threaded portion 402a and a non-threaded portion 402b. According to an embodiment, pivot boss shaft 402 further comprises a proximal opening to the hollow portion (see, e.g., top of pivot boss shaft 402 as depicted), configured to receive a corresponding threaded fastener (see, e.g., screw 406), and an opposing distal end (see, e.g., bottom of pivot boss shaft 402 as depicted) forming a pivot boss shaft length. According to an embodiment, the threaded portion 402a is positioned only in the distal half of the pivot boss shaft 402, which better ensures the desired fastening depth described in more detail hereafter. According to a related embodiment, the internal threaded portion 402a is positioned such that the substantially center threads are positioned at or approximate to 64% (sixty four percent) of the pivot boss shaft 402 length, or more. According to an embodiment, pivot boss shaft 402 further comprises a counterbore 402c extending from the threaded portion toward the distal end, thus providing for the desired fastening depth plus additional pivot boss shaft 402 length to prevent tilting after HSA (head-stack assembly) installation.

Pivot assembly 400 is fixed/fastened to the base 408 by way of a screw 406, which is coupled with the threaded portion 402a of the pivot boss shaft 402 through a cover 410 which is otherwise coupled with the base 408. Screw 406 is configured to have an associated screw fastening depth, labeled “FD” for “fastening depth”, which is defined by the distance between the top of the pivot shaft 404 and the position at which substantially center threads of the threaded portion 402a of pivot boss shaft 402 are coupled with screw 406 threads. The center of the threaded portion 402a is shown and labeled 402ac. Notably and according to an embodiment, here the screw fastening depth FD of screw 406 is configured at 66% (sixty six percent) or more of the pivot shaft length L of pivot shaft 404. As such, the FD is deeper than with pivot assembly 300 (FIG. 3), thereby reducing the thermal expansion of the pivot boss shaft 402 at relatively high temperature (for a non-limiting example, in a range of 30° C.-60° C.), at least in part because the screw 406 is longer than screw 306 (FIG. 3) and the corresponding fastening position is lower within the pivot assembly 400 generally and within the pivot boss shaft 402 and pivot shaft 404 particularly. Likewise, the axial fastening force corresponding with screw 406 is greater than with screw 306 at high temperatures, i.e., the screw fastening force between the pivot assembly 400 and the cover 410 is maintained and does not decrease as much as with pivot assembly 300.

According to a related embodiment, the screw fastening depth FD is configured in a range of 66%-100% (just under one hundred percent) of the pivot shaft length L, thus eliminating or at least inhibiting the leakage of air or gas (e.g., helium) from inside the enclosure such as with a screw that may extend deeper into and/or beyond the outer surface of the base casting/component. Note that the described FD of 66%, as well as any other FD that may be derived and/or implemented, is based on the specific materials of which the pivot boss shaft 402, pivot shaft 404, and screw 406 are composed. For a non-limiting example, the 66% FD is based on pivot boss shaft 402 being composed of an aluminum alloy (e.g., ADC12 aluminum having CTE around 21e-6/K), a pivot shaft 404 being composed of stainless steel (e.g., DHS-1B steel having CTE around 10.4e-6/K), and a screw 406 being composed of a carbon steel (e.g., SWCH16A carbon steel). However, the materials used for the pivot boss shaft 402, the pivot shaft 404, and the screw 406 may vary from implementation to implementation, e.g., based on the structural needs, design goals, material availability, and the like. Likewise, the screw fastening depth FD may also vary from implementation to implementation, e.g., based on the materials used for the respective parts and their corresponding CTEs. Note that in a scenario in which the pivot boss shaft 402 and pivot shaft 404 materials have a larger difference in CTE than that exemplified above for ADC12 aluminum and DHS-1B steel materials, then it is expected that the screw fastening depth would exceed 66% accordingly.

Continuing, because the axial force of the pivot screw 406 decreases less or minimally consequent to the difference of CTE's of the base boss shaft 402 and corresponding pivot shaft 404 at higher temperatures, the coil torsion mode gain in the frequency response functions is reduced and the change (lowering) in the main resonance frequency (see, e.g., main resonance mode 202 of FIG. 2) at higher temperatures is inhibited and reduced in comparison with pivot assembly 300. Therefore, the coil torsion mode (see, e.g., coil torsion mode 204 of FIG. 2) does not more closely couple (e.g., closer in frequency) with and thus is not as detrimentally affected by the main resonance mode 202 at higher temperatures as with pivot assembly 300.

### Method for Assembling a Hard Disk Drive

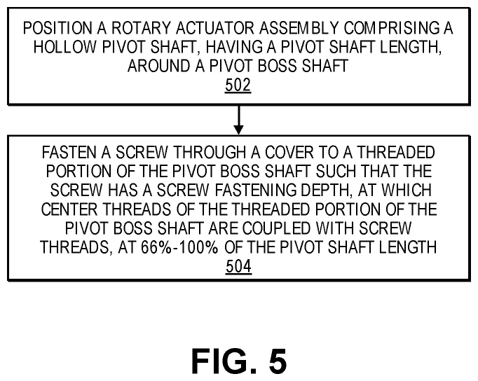

FIG. 5 is a flowchart illustrating a method of assembling a hard disk drive, according to an embodiment.

At block 502, position a rotary actuator assembly comprising a hollow pivot shaft, having a pivot shaft length, around a pivot boss shaft. For example, position the HSA of FIG. 1, including pivot shaft 404 (FIG. 4) having pivot shaft length L (FIG. 4), around pivot boss shaft 402 (FIG. 4) of base 408.

At block 504, fasten a screw through a cover to a threaded portion of the pivot boss shaft such that the screw has a screw fastening depth, at which center threads of the threaded portion of the pivot boss shaft are coupled with screw threads, at 66%-100% of the pivot shaft length. For example, screw 406 (FIG. 4) is inserted through cover 410 (FIG. 4) and into the proximal opening of the pivot boss shaft 402, so that the threads of the screw 406 reach the center 402ac of the threaded portion 402a positioned in a distal half of the pivot boss shaft 402 at a fastening depth FD (FIG. 4) of at least 66%, up to nearly 100%, of the pivot shaft 404 length L.

### Physical Description of an Illustrative Operating Context

Embodiments may be used in the context of a digital data storage device (DSD) such as a hard disk drive (HDD). Thus, in accordance with an embodiment, a plan view illustrating a conventional HDD 100 is shown in FIG. 1 to aid in describing how a conventional HDD typically operates.

FIG. 1 illustrates the functional arrangement of components of the HDD 100 including a slider 110b that includes a magnetic read-write head 110a. Collectively, slider 110b and head 110a may be referred to as a head slider. The HDD 100 includes at least one head gimbal assembly (HGA) 110 including the head slider, a lead suspension 110c attached to the head slider typically via a flexure, and a load beam 110d attached to the lead suspension 110c. The HDD 100 also includes at least one recording medium 120, but commonly multiple recording media 120, rotatably mounted on a spindle 124 and a drive motor (not visible) attached to the spindle 124 for rotating the medium 120. The read-write head 110a, which may also be referred to as a transducer, includes a write element and a read element for respectively writing and reading information stored on the medium 120 of the HDD 100. The medium 120 or a plurality of disk media may be affixed to the spindle 124 with a disk clamp 128.

The HDD 100 further includes an arm 132 attached to the HGA 110, a carriage 134, a voice-coil motor (VCM) that includes an armature 136 including a voice coil 140 attached to the carriage 134 and a stator 144 including a voice-coil magnet (not visible). The armature 136 of the VCM is attached to the carriage 134 and is configured to move the arm 132 and the HGA 110 to access portions of the medium 120, all collectively mounted on a pivot shaft 148 with an interposed pivot bearing assembly 152. In the case of an HDD having multiple disks, the carriage 134 may be referred to as an “E-block,” or comb, because the carriage is arranged to carry a ganged array of arms that gives it the appearance of a comb.

An assembly comprising a head gimbal assembly (e.g., HGA 110) including a flexure to which the head slider is coupled, an actuator arm (e.g., arm 132) and/or load beam to which the flexure is coupled, and an actuator (e.g., the VCM) to which the actuator arm is coupled, may be collectively referred to as a head-stack assembly (HSA). An HSA may, however, include more or fewer components than those described. For example, an HSA may refer to an assembly that further includes electrical interconnection components. Generally, an HSA is the assembly configured to move the head slider to access portions of the medium 120 for read and write operations. The HSA is configured to mechanically interact with a load/unload (LUL) ramp 190 to move the head stack assembly (HSA), including the read-write head sliders, away from and off the disks and to safely position them onto the supporting structure of the LUL ramp.

With further reference to FIG. 1, electrical signals (e.g., current to the voice coil 140 of the VCM) comprising a write signal to and a read signal from the head 110a, are transmitted by a flexible cable assembly (FCA) 156 (or “flex cable”, or “flexible printed circuit” (FPC)). Interconnection between the flex cable 156 and the head 110a may include an arm-electronics (AE) module 160, which may have an on-board pre-amplifier for the read signal, as well as other read-channel and write-channel electronic components. The AE module 160 may be attached to the carriage 134 as shown. The flex cable 156 may be coupled to an electrical-connector block 164, which provides electrical communication, in some configurations, through an electrical feed-through provided by an HDD housing 168. The HDD housing 168 (or “enclosure base” or “baseplate” or simply “base”), in conjunction with an HDD cover, provides a semi-sealed (or hermetically sealed, in some configurations) protective enclosure for the information storage components of the HDD 100.

Other electronic components, including a disk controller and servo electronics including a digital-signal processor (DSP), provide electrical signals to the drive motor, the voice coil 140 of the VCM and the head 110a of the HGA 110. The electrical signal provided to the drive motor enables the drive motor to spin providing a torque to the spindle 124 which is in turn transmitted to the medium 120 that is affixed to the spindle 124. As a result, the medium 120 spins in a direction 172. The spinning medium 120 creates a cushion of air that acts as an air-bearing on which the air-bearing surface (ABS) of the slider 110b rides so that the slider 110b flies above the surface of the medium 120 without making contact with a thin magnetic-recording layer in which information is recorded. Similarly in an HDD in which a lighter-than-air gas is utilized, such as helium for a non-limiting example, the spinning medium 120 creates a cushion of gas that acts as a gas or fluid bearing on which the slider 110b rides.

The electrical signal provided to the voice coil 140 of the VCM enables the head 110a of the HGA 110 to access a track 176 on which information is recorded. Thus, the armature 136 of the VCM swings through an arc 180, which enables the head 110a of the HGA 110 to access various tracks on the medium 120. Information is stored on the medium 120 in a plurality of radially nested tracks arranged in sectors on the medium 120, such as sector 184. Correspondingly, each track is composed of a plurality of sectored track portions (or “track sector”) such as sectored track portion 188. Each sectored track portion 188 may include recorded information, and a header containing error correction code information and a servo-burst-signal pattern, such as an ABCD-servo-burst-signal pattern, which is information that identifies the track 176. In accessing the track 176, the read element of the head 110a of the HGA 110 reads the servo-burst-signal pattern, which provides a position-error-signal (PES) to the servo electronics, which controls the electrical signal provided to the voice coil 140 of the VCM, thereby enabling the head 110a to follow the track 176. Upon finding the track 176 and identifying a particular sectored track portion 188, the head 110a either reads information from the track 176 or writes information to the track 176 depending on instructions received by the disk controller from an external agent, for example, a microprocessor of a computer system.

An HDD's electronic architecture comprises numerous electronic components for performing their respective functions for operation of an HDD, such as a hard disk controller (“HDC”), an interface controller, an arm electronics module, a data channel, a motor driver, a servo processor, buffer memory, etc. Two or more of such components may be combined on a single integrated circuit board referred to as a “system on a chip” (“SOC”). Several, if not all, of such electronic components are typically arranged on a printed circuit board that is coupled to the bottom side of an HDD, such as to HDD housing 168.

References herein to a hard disk drive, such as HDD 100 illustrated and described in reference to FIG. 1, may encompass an information storage device that is at times referred to as a “hybrid drive”. A hybrid drive refers generally to a storage device having functionality of both a traditional HDD (see, e.g., HDD 100) combined with solid-state storage device (SSD) using non-volatile memory, such as flash or other solid-state (e.g., integrated circuits) memory, which is electrically erasable and programmable. As operation, management and control of the different types of storage media typically differ, the solid-state portion of a hybrid drive may include its own corresponding controller functionality, which may be integrated into a single controller along with the HDD functionality. A hybrid drive may be architected and configured to operate and to utilize the solid-state portion in a number of ways, such as, for non-limiting examples, by using the solid-state memory as cache memory, for storing frequently-accessed data, for storing I/O intensive data, and the like. Further, a hybrid drive may be architected and configured essentially as two storage devices in a single enclosure, i.e., a traditional HDD and an SSD, with either one or multiple interfaces for host connection.

### Extensions and Alternatives

In the foregoing description, embodiments of the invention have been described with reference to numerous specific details that may vary from implementation to implementation. Therefore, various modifications and changes may be made thereto without departing from the broader spirit and scope of the embodiments. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

In addition, in this description certain process steps may be set forth in a particular order, and alphabetic and alphanumeric labels may be used to identify certain steps. Unless specifically stated in the description, embodiments are not necessarily limited to any particular order of carrying out such steps. In particular, the labels are used merely for convenient identification of steps, and are not intended to specify or require a particular order of carrying out such steps.

What is claimed is:

1. A data storage device comprising:
a plurality of disk media rotatably mounted on a spindle;
a head slider comprising a read-write head configured to write to and to read from at least one disk medium of the plurality of disk media;
a rotary actuator assembly configured to move the head slider about a pivot to access portions of the disk medium via actuation by a voice coil motor actuator (VCMA), the pivot comprising an at least partially hollow pivot shaft having a pivot shaft length;
an enclosure base comprising a pivot boss shaft comprising an internal threaded portion and at least in part disposed within the pivot shaft;
a cover coupled with the base to form an enclosure; and
a screw coupled with the threaded portion of the pivot boss shaft through the cover, the screw having a screw fastening depth, at which center threads of the threaded portion of the pivot boss shaft are coupled with screw threads, at 66% or more of the pivot shaft length.

2. The data storage device of claim 1, wherein the screw fastening depth is less than 100% of the pivot shaft length.

3. The data storage device of claim 1, wherein:
the pivot boss shaft comprises a proximal opening to a hollow portion and an opposing distal end; and
the threaded portion of the pivot boss shaft is positioned only in a distal half of the pivot boss shaft.

4. The data storage device of claim 1, wherein the pivot further comprises at least one bearing ring positioned around the pivot shaft.

5. The data storage device of claim 1, wherein the enclosure base and the pivot boss shaft are an integrally-formed component.

6. The data storage device of claim 1, wherein the pivot boss shaft has a higher coefficient of thermal expansion than the coefficient of thermal expansion of the pivot shaft.

7. A hard disk drive (HDD) enclosure base comprising:
a hollow pivot boss shaft comprising:
a proximal top opening configured to receive a threaded fastener;
a distal end opposing the proximal top opening and forming a pivot boss shaft length defined as the distance between the proximal top and the distal end; and
an internal threaded portion having a center positioned at 64% or more of the pivot boss shaft length.

8. The HDD enclosure base of claim 7, wherein the pivot boss shaft further comprises a counterbore extending from the threaded portion toward the distal end.

9. The HDD enclosure base of claim 7, wherein the pivot boss shaft is formed as an integral part with the enclosure base.

10. A method of assembling a hard disk drive, the method comprising:
positioning around a pivot boss shaft a rotary actuator assembly comprising a hollow pivot shaft having a pivot shaft length and one or more bearing rings positioned around the pivot shaft; and
fastening a screw through a cover to a threaded portion of the pivot boss shaft such that the screw has a screw fastening depth, at which center threads of the threaded portion of the pivot boss shaft are coupled with screw threads, at 66%-100% of the pivot shaft length.

11. The method of claim 10, wherein:
the pivot boss shaft comprises a proximal opening and an opposing distal end and the threaded portion of the pivot boss shaft is positioned only in a distal half of the pivot boss shaft.
